(19) United States
(12) Patent Application Publication
(10) Pub. No.: US 2018/0059527 A1
(43) Pub. Date: Mar. 1, 2018

(54) MOUNTABLE PROJECTOR

(71) Applicant: Matthew Aaron Alexander, Powell, WY (US)

(72) Inventor: Matthew Aaron Alexander, Powell, WY (US)

(21) Appl. No.: 15/695,873

(22) Filed: Sep. 5, 2017

Related U.S. Application Data
(63) Continuation of application No. 15/688,708, filed on Aug. 28, 2017.
Application No. 15/688,708 is a division of application No. 15/688,720, filed on Aug. 28, 2017.
(60) Provisional application No. 62/380,173, filed on Aug. 26, 2016.
(60) Provisional application No. 62/380,181, filed on Aug. 26, 2016.
(60) Provisional application No. 62/380,173, filed on Aug. 26, 2016.
(60) Provisional application No. 62/380,181, filed on Aug. 26, 2016.

(51) Int. Cl. G03B 21/28; G03B 21/14; G03B 21/20; H04N 9/31

(52) U.S. Cl. CPC G03B 21/28; G03B 21/145; G03B 21/2006; G03B 21/62; G03B 2217/007; G09G 2340/0464; G09G 2370/04; H04N 9/3141

(57) ABSTRACT

A mountable projector for illuminating an area near the mountable projector. The mountable projector includes a body and a light source, the light source providing light. The mountable projector also includes an image filter, where the light from the light source passes through the image filter and produces an image and a lens, where the lens focuses the image produced by the light filter. The mountable projector also includes an attachment, where the attachment is configured to allow the body to be mounted to a desired surface.

### CROSS-REFERENCE TO RELATED APPLICATIONS

This application is a continuation of, and claims the benefit of and priority to, U.S. Non-Provisional patent application Ser. No. 15/688,708 filed on Aug. 28, 2017, which application is incorporated herein by reference in its entirety.

This application is a division of, claims the benefit of and priority to, U.S. Non-Provisional patent application Ser. No. 15/688,720 filed on Aug. 28, 2017, which application is incorporated herein by reference in its entirety.

U.S. Non-Provisional patent application Ser. No. 15/688,708 incorporated U.S. Non-Provisional patent application Ser. No. 15/688,720 by reference in its entirety.

U.S. Non-Provisional patent applications Ser. Nos. 15/688,708 and 15/688,720 claim the benefit of and priority to U.S. Provisional Patent Application Ser. No. 62/379,890 filed on Aug. 26, 2016, which application is incorporated herein by reference in its entirety.

U.S. Non-Provisional patent applications Ser. Nos. 15/688,708 and 15/688,720 claim the benefit of and priority to U.S. Provisional Patent Application Ser. No. 62/380,173 filed on Aug. 26, 2016, which application is incorporated herein by reference in its entirety.

U.S. Non-Provisional patent applications Ser. Nos. 15/688,708 and 15/688,720 claim the benefit of and priority to U.S. Provisional Patent Application Ser. No. 62/380,181 filed on Aug. 26, 2016, which application is incorporated herein by reference in its entirety.

### BACKGROUND OF THE INVENTION

One problem that is faced by almost many people in modern conditions is having to enter the bathroom in the dark at night without being able to see. Typically, the solutions to this are to place a night light or other low-level light within the bathroom to accommodate any individuals that desire to use the bathroom in low light conditions. However, nightlights are, of necessity, located where power is available, which is often not near the toilet, rather than where they are needed. In addition, night lights typically turn on during low light conditions, meaning they may be on for a significant portion of the day, which results in inefficient power consumption.

Accordingly, there is a need in the art for a low power consumption light that illuminates only the area being used in low light conditions.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a mountable projector for illuminating an area near the mountable projector. The mountable projector includes a body and a light source, the light source providing light. The mountable projector also includes an image filter, where the light from the light source passes through the image filter and produces an image and a lens, where the lens focuses the image produced by the light filter. The mountable projector also includes an attachment, where the attachment is configured to allow the body to be mounted to a desired surface.

Another example embodiment includes a mountable projector for illuminating an area near the mountable projector. The mountable projector includes a body and a light source, the light source providing light. The mountable projector also includes a first image filter, where the light from the light source passes through the first image filter and produces a first image and a second image filter, where the light from the light source passes through the second image filter and produces a second image. The mountable projector further includes an image selector, where the image selector allows a user to select between the first image filter and the second image filter for current use and a lens, where the lens focuses the image produced by the light filter. The mountable projector additionally includes a power source, where the power source provides power to the light source and a polyurethane gel pad, where the polyurethane gel pad is configured to allow the body to be mounted to a desired surface.

Another example embodiment includes a mountable projector for illuminating an area near the mountable projector. The mountable projector includes a body and a light source, the light source providing light. The mountable projector also includes a first image filter, where the light from the light source passes through the first image filter and produces a first image and a second image filter, where the light from the light source passes through the second image filter and produces a second image. The mountable projector further includes an image selector, where the image selector allows a user to select between the first image filter and the second image filter for current use and a lens, where the lens focuses the image produced by the light filter. The mountable projector additionally includes a power source, where the power source provides power to the light source and a polyurethane gel pad, where the polyurethane gel pad is configured to allow the body to be mounted to a desired surface. The mountable projector moreover includes one or more sensors, where the one or more sensors are configured to set the conditions for use. The one or more sensors activate the light source for a predetermined period of time when the desired conditions for use are met.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a front view of the example of a mountable projector;

FIG. 1B illustrates a side view of the example of a mountable projector;

FIG. 1C illustrates a rear view of the example of a mountable projector;

FIG. 2 illustrates an example of a mountable projector in use; and

FIG. 3 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

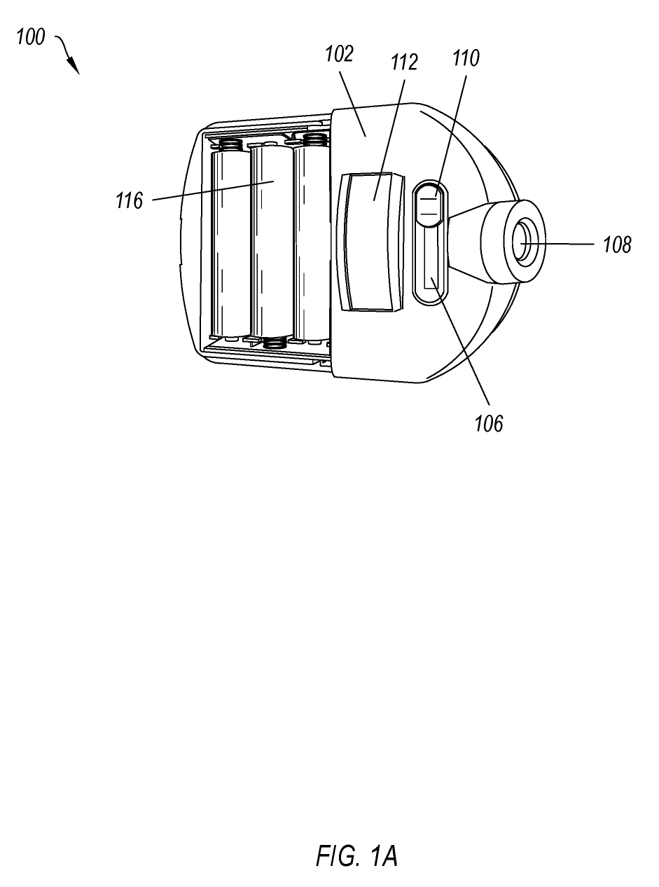

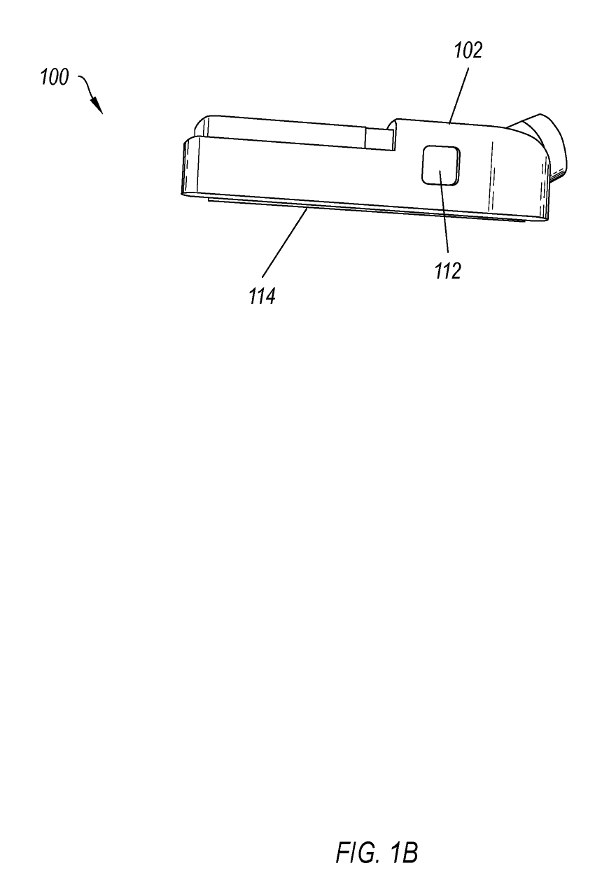

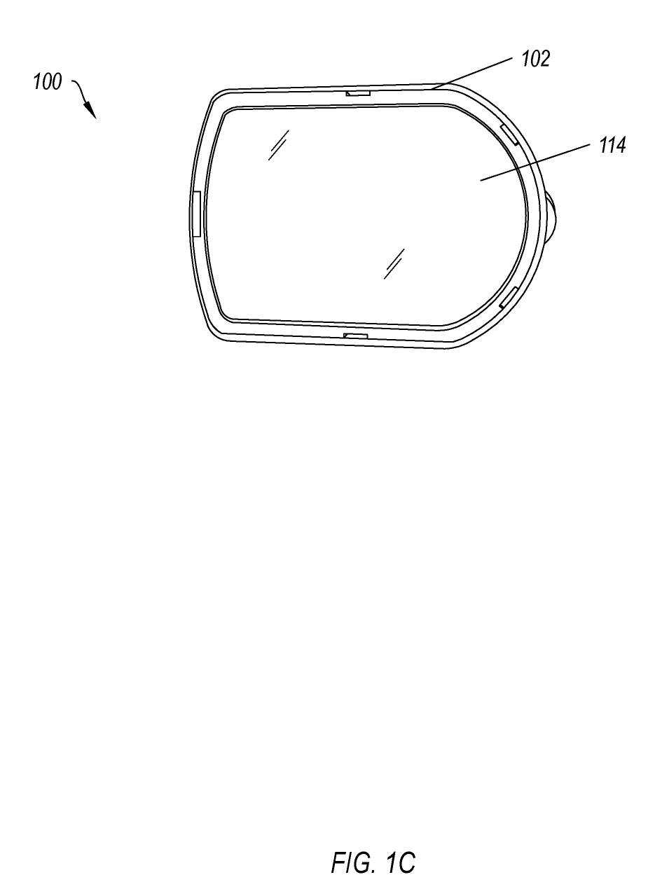

FIGS. 1A, 1B and 1C (collectively “FIG. 1”) illustrate an example of a mountable projector 100. FIG. 1A illustrates a front view of the example of a mountable projector 100; FIG. 1B illustrates a side view of the example of a mountable projector 100; and FIG. 1C illustrates a rear view of the example of a mountable projector 100. The mountable projector 100 can mount to any desired surface. For example, the mountable projector 100 can be secured to a vertical surface, such as a wall, to a movable surface, such as a door or toilet seat. The mountable projector can act as a nightlight or other illumination source. For example, the mountable projector can produce an image on a wall, floor, toiler bowl, or other surface, to illuminate the surface and/or surrounding area. When the mountable projector 100 is being used as a light source it is critical that the mountable projector 100 be lightweight. For example, the mountable projector can be between 1 and 2 ounces (without batteries), thus ensuring that the mountable projector 100 can remain in place. In particular, the mountable projector 100 can be approximately 1.5 ounces (without batteries). As used in the specification and the claims, the term approximately shall mean that the value is within 10% of the stated value, unless otherwise specified.

FIG. 1 shows that the mountable projector 100 can include a body 102. In at least one implementation, the body 102 is the main portion of the mountable projector 100. For example, the body 102 can be used to connect and/or protect the other elements of the mountable projector 100. That is, the body 102 can form a case or cover around some or all of the other elements of the mountable projector 100. The body 102 can include any desired material, such as plastic or metal.

Although not shown in FIG. 1, one of skill in the art will understand that the mountable projector 100 can include a light source. The light source can include any desired light source, such as an LED or other light source. For example, the light source can include a bulb or LED that produces white light.

FIG. 1 further shows that the mountable projector 100 can include an image filter 106. The image filter 106 allows the user to select the image that is being projected. I.e., light is produced at the light source then passes through the image filter 106 producing the image that will be seen by a user. The mountable projector 100 can include a single image filter 106 or multiple image filters 106 that allow a user to select from a number of images.

FIG. 1 additionally shows that the mountable projector 100 can include a lens 108. The lens 108 allows the projected image to be seen by a user. That is, the lens 108 brings the projected image into focus so that it can be viewed by a user. The lens 108 is a transmissive optical device that focuses or disperses a light beam by means of refraction. A simple lens consists of a single piece of transparent material, while a compound lens consists of several simple lenses (elements), usually arranged along a common axis. Lens 108 can include either a simple lens or compound lens as desired. Lens 108 can include materials such as glass or plastic, and are ground and polished or molded to a desired shape.

FIG. 1 moreover shows that the mountable projector 100 can include an image selector 110. The image selector 110 allows a user to select a desired image. For example, the image selector can include a slide switch that allows a user to move a series of image filters 106 between the light source and the lens 108. One of skill in the art will appreciate that the light source, image selector 110 and/or the image filter 106 can be physical elements (e.g., a transparent film and physical switch) or can be digital (e.g., a programable LED chip) or some combination thereof, as described below.

FIG. 1 also shows that the mountable projector 100 can include one or more sensors 112. The sensors 112 can allow the user to select conditions of use. For example, the sensors 112 can include motion and light sensors such that the mountable projector is only activated in low light conditions and when movement occurs (i.e., a person is present in low light conditions). When the one or more sensors 112 turn on the light source the light source can remain on for a specified period of time. For example, the specified period of time can be between one and three minutes. In particular, the specified period of time can be approximately two minutes.

FIG. 1 further shows that the mountable projector 100 can include an attachment 114. The attachment 114 is configured to allow the user to place the mountable projector 100 on a desired surface, such as a toilet lid. For example, the attachment 114 can include a polyurethane (PU) gel pad. A PU gel pad can be reused. For example, the PU gel pad can be peeled from the toilet, rinsed, then reused on a different (or the same) surface (e.g., a wall). As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 additionally shows that the mountable projector 100 can include a power source 116. The power source 116 powers the light source and/or any other control components of the mountable projector 100. For example, the power source 116 can include a cord or batteries. One of skill in the art will appreciate that the power provided by the power source 116 is a balance of factors, such as weight vs power needed.

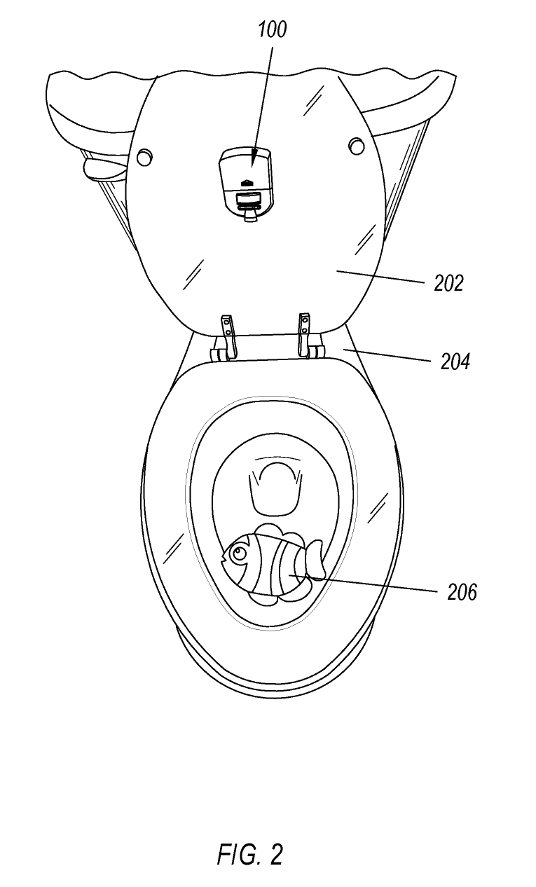

FIG. 2 illustrates an example of a mountable projector 100 in use. In particular, FIG. 2 illustrates an example of a mountable projector 100 attached to a toilet lid 202. Thus, the mountable projector 100 acts as a nightlight, such that when a user enters a darkened bathroom, the mountable projector 100 illuminates the toilet 204.

FIG. 2 shows that the mountable projector 100 is producing an image 206 within the toilet 204. The image can be predesigned, or can be programable. I.e., the image 206 can be produced with a physical filter that produces only a single image (or a series of selectable images) or can be produced with a chip which allows for image selection or programing.

FIG. 2 also shows that the mountable projector 100 can project the image 206 into the bowl of the toilet 204. This illuminates only the area that the user wishes to view. I.e., the user may be in a situation, such as the middle of the night, where excess light is unwanted and the image 206 in the bowl of the toilet 204 ensures that the light is bright enough for the user to see without being overly bright.

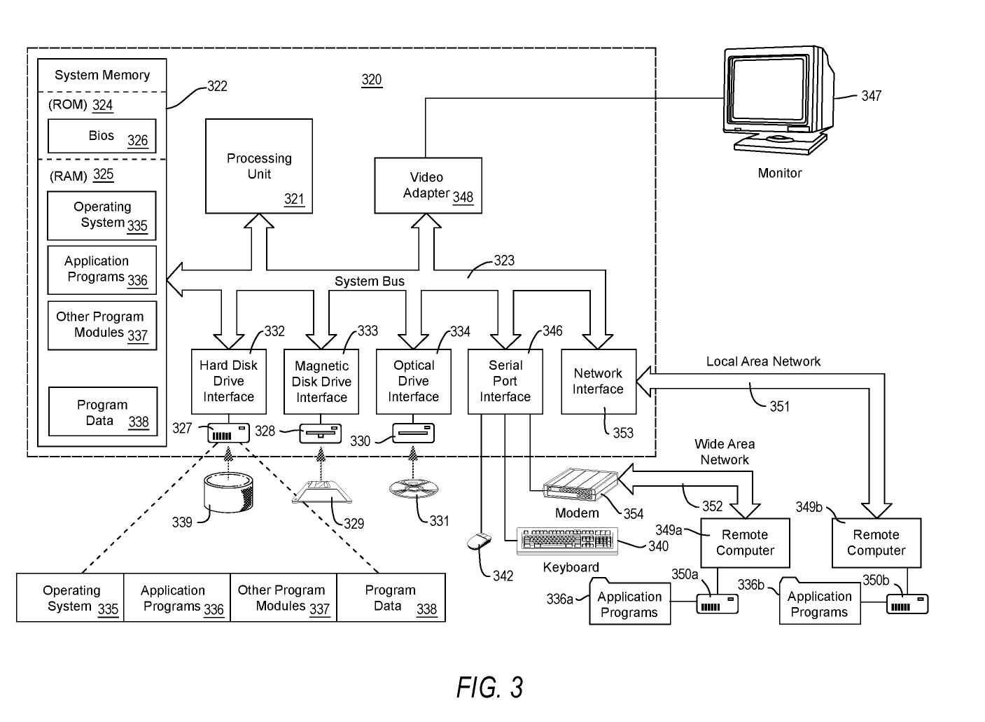

FIG. 3, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 3, an example system for implementing the invention includes a general purpose computing device in the form of a conventional computer 320, including a processing unit 321, a system memory 322, and a system bus 323 that couples various system components including the system memory 322 to the processing unit 321. It should be noted however, that as mobile phones become more sophisticated, mobile phones are beginning to incorporate many of the components illustrated for conventional computer 320. Accordingly, with relatively minor adjustments, mostly with respect to input/output devices, the description of conventional computer 320 applies equally to mobile phones. The system bus 323 may be any of several types of bus structures including a memory bus or memory controller, a peripheral bus, and a local bus using any of a variety of bus architectures. The system memory includes read only memory (ROM) 324 and random access memory (RAM) 325. A basic input/output system (BIOS) 326, containing the basic routines that help transfer information between elements within the computer 320, such as during start-up, may be stored in ROM 324.

The computer 320 may also include a magnetic hard disk drive 327 for reading from and writing to a magnetic hard disk 339, a magnetic disk drive 328 for reading from or writing to a removable magnetic disk 329, and an optical disc drive 330 for reading from or writing to removable optical disc 331 such as a CD-ROM or other optical media. The magnetic hard disk drive 327, magnetic disk drive 328, and optical disc drive 330 are connected to the system bus 323 by a hard disk drive interface 332, a magnetic disk drive-interface 333, and an optical drive interface 334, respectively. The drives and their associated computer-readable media provide nonvolatile storage of computer-executable instructions, data structures, program modules and other data for the computer 320. Although the exemplary environment described herein employs a magnetic hard disk 339, a removable magnetic disk 329 and a removable optical disc 331, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 339, magnetic disk 329, optical disc 331, ROM 324 or RAM 325, including an operating system 335, one or more application programs 336, other program modules 337, and program data 338. A user may enter commands and information into the computer 320 through keyboard 340, pointing device 342, or other input devices (not shown), such as a microphone, joy stick, game pad, satellite dish, scanner, motion detectors or the like. These and other input devices are often connected to the processing unit 321 through a serial port interface 346 coupled to system bus 323. Alternatively, the input devices may be connected by other interfaces, such as a parallel port, a game port or a universal serial bus (USB). A monitor 347 or another display device is also connected to system bus 323 via an interface, such as video adapter 348. In addition to the monitor, personal computers typically include other peripheral output devices (not shown), such as speakers and printers.

The computer 320 may operate in a networked environment using logical connections to one or more remote computers, such as remote computers 349a and 349b. Remote computers 349a and 349b may each be another personal computer, a server, a router, a network PC, a peer device or other common network node, and typically include many or all of the elements described above relative to the computer 320, although only memory storage devices 350a and 350b and their associated application programs 336a and 336b have been illustrated in FIG. 3. The logical connections depicted in FIG. 3 include a local area network (LAN) 351 and a wide area network (WAN) 352 that are presented here by way of example and not limitation. Such networking environments are commonplace in office-wide or enterprise-wide computer networks, intranets and the Internet.

When used in a LAN networking environment, the computer 320 can be connected to the local network 351 through a network interface or adapter 353. When used in a WAN networking environment, the computer 320 may include a modem 354, a wireless link, or other means for establishing communications over the wide area network 352, such as the Internet. The modem 354, which may be internal or external, is connected to the system bus 323 via the serial port interface 346. In a networked environment, program modules depicted relative to the computer 320, or portions thereof, may be stored in the remote memory storage device. It will be appreciated that the network connections shown are exemplary and other means of establishing communications over wide area network 352 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mountable projector for illuminating an area near the mountable projector, the mountable projector comprising:
a body;
a light source, the light source providing light;
an image filter, wherein the light from the light source passes through the image filter and produces an image;
a lens, wherein the lens focuses the image produced by the light filter; and
an attachment, wherein the attachment is configured to allow the body to be mounted to a desired surface.

2. The mountable projector of claim 1, wherein the weight of the mountable projector is between one ounce and two ounces.

3. The mountable projector of claim 2, wherein the weight of the mountable projector is approximately 1.5 ounces.

4. The mountable projector of claim 1, wherein the attachment includes a polyurethane gel pad.

5. The mountable projector of claim 1, wherein the light source includes a light emitting diode.

6. The mountable projector of claim 1, wherein the body includes plastic.

7. The mountable projector of claim 1, wherein the lens includes a compound lens.

8. The mountable projector of claim 1, wherein the lens includes a simple lens.

9. A mountable projector for illuminating an area near the mountable projector, the mountable projector comprising:
a body;
a light source, the light source providing light;
a first image filter, wherein the light from the light source passes through the first image filter and produces a first image;
a second image filter, wherein the light from the light source passes through the second image filter and produces a second image;
an image selector, wherein the image selector allows a user to select between the first image filter and the second image filter for current use;
a lens, wherein the lens focuses the image produced by the light filter;
a power source, wherein the power source provides power to the light source; and
a polyurethane gel pad, wherein the polyurethane gel pad is configured to allow the body to be mounted to a desired surface.

10. The mountable projector of claim 9, wherein the power source includes one or more batteries.

11. The mountable projector of claim 9 further comprising a circuit board, the circuit board allowing a user to upload a desired image as an image filter.

12. The mountable projector of claim 9, wherein the light source, the image filter and the image selector are located on a chip.

13. A mountable projector for illuminating an area near the mountable projector, the mountable projector comprising:
a body;
a light source, the light source providing light;
a first image filter, wherein the light from the light source passes through the first image filter and produces a first image;
a second image filter, wherein the light from the light source passes through the second image filter and produces a second image;
an image selector, wherein the image selector allows a user to select between the first image filter and the second image filter for current use;
a lens, wherein the lens focuses the image produced by the light filter;
a power source, wherein the power source provides power to the light source;
a polyurethane gel pad, wherein the polyurethane gel pad attaches the body to a surface; and
one or more sensors, wherein the one or more sensors are configured to set the conditions for use;
wherein the one or more sensors activate the light source for a predetermined period of time when the desired conditions for use are met.

14. The mountable projector of claim 13, wherein the one or more sensors include a light sensor.

15. The mountable projector of claim 13, wherein the one or more sensors include a motion sensor.

16. The mountable projector of claim 13, wherein the predetermined period of time includes between one minute and three minutes.

17. The mountable projector of claim 13, wherein the predetermined period of time includes approximately two minutes.

18. The mountable projector of claim 13, wherein the surface includes a toilet lid.

19. The mountable projector of claim 13, wherein the surface includes a wall.
